(19) United States
(12) Patent Application Publication
(10) Pub. No.: US 2024/0313559 A1
(43) Pub. Date: Sep. 19, 2024

(54) POWER BANK SET

(71) Applicant: Longjie HONG, Fujian (CN)

(72) Inventor: Longjie HONG, Fujian (CN)

(21) Appl. No.: 18/143,077

(22) Filed: May 4, 2023

(30) Foreign Application Priority Data
Mar. 17, 2023 (CN) 202320526888.7

(51) Int. Cl. H02J 7/00; H01R 13/62; H02J 7/34

(52) U.S. Cl. CPC H02J 7/0045; H01R 13/6205; H02J 7/0013; H02J 7/342

(57) ABSTRACT

The present invention discloses a power bank set, including a primary power bank and an auxiliary power bank; the primary power bank has an assembling groove and a main charging interface; the auxiliary power bank has an auxiliary discharging connector and an auxiliary charging connector; when the auxiliary power bank is plugged into the assembling groove of the primary power bank, the auxiliary charging connector is connected with the primary discharging connector in the assembling groove. The primary power bank and the auxiliary power bank can be detachably assembled, so that different charging demands of people can be met.

### BACKGROUND OF THE INVENTION

The present invention relates to the field of power banks, and in particular to a power bank set.

A power bank is a device which is provided with an electricity storage unit and can directly charge mobile electronic equipment. The power bank is a high-capacity portable power supply, and also a portable device integrating electricity storage, voltage boosting, and charging management. Although there are various types of power banks on the market at present, almost all of them are structured as a single independent charging body. When a certain high amount of capacity is required, the power banks are large and heavy, thereby being inconvenient to carry. Particularly, the power banks are used in a single way, which is unable to meet demands for different use conditions.

In view of the above problems, it is necessary to develop a power bank set that combines a high-capacity primary power bank and a low-capacity auxiliary power bank detachable from each other, so that different charging demands of people can be met.

### BRIEF SUMMARY OF THE INVENTION

The present invention aims to provide a power bank set that combines a high-capacity primary power bank and a low-capacity auxiliary power bank detachable from each other, so that different charging demands of people can be met.

In order to achieve the above objectives, the present invention adopts the following solutions:

A power bank set, comprising a primary power bank and an auxiliary power bank; a capacity and a size of the primary power bank are both greater than a capacity and a size of the auxiliary power bank; the primary power bank is provided with an assembling groove and a main charging interface; a slot and a primary discharging connector configured to discharge power to an external device are arranged in the assembling groove; the auxiliary power bank is detachably plugged into the assembling groove of the primary power bank, and the auxiliary power bank is provided with an auxiliary discharging connector configured to discharge power to an external device, and an auxiliary charging connector for charging the auxiliary power bank; when the auxiliary power bank is plugged into the assembling groove of the primary power bank, the auxiliary discharging connector extends into the slot, and the auxiliary charging connector is connected with the primary discharging connector.

A stop step is formed on a circumferential edge of the slot; and the power bank is provided with a limiting portion that abuts against the stop step when the auxiliary power bank is plugged into the assembling groove of the primary power bank.

A housing of the auxiliary power bank is provided with a convex portion; when the auxiliary power bank is plugged into the assembling groove of the primary power bank, the convex portion of the housing of the auxiliary power bank flushes smoothly with a housing of the primary power bank.

The primary discharging connector is provided with a plurality of discharging contacts; and the auxiliary charging connector is provided with a plurality of charging contacts which are being in contact with the discharging contacts of the primary discharging connector respectively.

The auxiliary discharging connector and the primary discharging connector are both magnetic connectors; when the auxiliary power bank is plugged into the assembling groove of the primary power bank, the auxiliary charging connector and the primary discharging connector are magnetically attracted to each other.

The primary power bank and the auxiliary power bank are magnetically attracted to each other; the primary power bank is provided with primary magnetic blocks; and the auxiliary power bank is provided with auxiliary magnetic blocks magnetically corresponding to the primary magnetic blocks.

The auxiliary power bank is provided with a charging indicator; the primary power bank is provided with a light through hole communicated with an inner cavity of the assembling groove and corresponding to the charging indicator; when the auxiliary power bank is plugged into the assembling groove of the primary power bank, the charging indicator of the housing of the auxiliary power bank directly faces the light through hole of the primary power bank.

An auxiliary power bank circuit board and an auxiliary cell are arranged in the auxiliary power bank; and the auxiliary power bank circuit board is electrically connected to the auxiliary cell, the charging indicator, the auxiliary charging connector, and the auxiliary discharging connector.

The primary power bank is provided with an operation key and a display screen that displays a state of the primary power bank.

The operation key comprises a push switch and a key cap; the push switch is provided inside the housing of the primary power bank, and the housing of the primary power bank is provided with a key hole corresponding to the push switch; the key cap comprises a key cap body and at least two elastic arms connected with the key cap body; the key cap body is accommodated in the key hole; and the elastic arms are connected with an inner side of the housing.

Each elastic arm has an S-shape.

The primary power bank is further provided with a secondary charging interface; and a type of the secondary charging interface is different from a type of the main charging interface.

A primary power bank circuit board and at least one primary cell are arranged in the primary power bank; and the primary power bank circuit board is electrically connected to said at least one primary cell, the main charging interface, the primary discharging connector, and the secondary charging interface.

By the adoption of the above schemes, both the primary power bank and the auxiliary power bank of the present invention can independently charge an external electronic equipment, so that a user can select the primary power bank or the auxiliary power bank for charging according to different charging demands. The capacity and size of the primary power bank are greater than those of the auxiliary power bank, so that the primary power bank is suitable for a charging scenario in which the user requires high-capacity charging and/or a charging scene in which the user does not need to hold the primary power bank. The auxiliary power bank is provided with the auxiliary discharging connector that can be directly plugged into the charging interface of the electronic equipment to charge the electronic equipment. The capacity and size of the auxiliary power bank are smaller than those of the primary power bank, so that the auxiliary power bank is relatively lighter than the primary power bank. In this way, a load is relatively small when the user holds the electronic equipment and the auxiliary power bank for charging, which will not pose a burden on the user during use. In addition, the primary power bank and the auxiliary power bank of the present invention can be detachably assembled together, which is convenient for the user to carry. When the primary power bank and the auxiliary power bank are assembled together, the auxiliary power bank is plugged into the assembling groove of the primary power bank, and the auxiliary discharging connector of the auxiliary power bank extends into the slot, so that the auxiliary discharging connector can be effectively protected from being bumped and crashed.

Also, the primary power bank can also charge the auxiliary power bank, which is convenient for the user to charge the auxiliary power bank. Furthermore, the auxiliary power bank is charged by the primary power bank through the connection between the auxiliary charging connector of the auxiliary power bank and the primary discharging connector of the primary power bank, which is helpful in effectively reducing the frequency of use of the auxiliary discharging connector and thereby prolonging the service life of the auxiliary discharging connector.

### BRIEF DESCRIPTION OF THE DRAWINGS

FIG. 1 is a schematic diagram I of combination of a primary power bank and an auxiliary power bank of the present invention;

FIG. 2 is a schematic diagram Il of combination of a primary power bank and an auxiliary power bank of the present invention;

FIG. 3 is a sectional diagram I of combination of a primary power bank and an auxiliary power bank of the present invention;

FIG. 4 is a sectional diagram Il of combination of a primary power bank and an auxiliary power bank of the present invention;

FIG. 5 is a sectional diagram Ill of combination of a primary power bank and an auxiliary power bank of the present invention;

FIG. 6 is a schematic diagram of a primary power bank and an auxiliary power bank of the present invention in a separated condition;

FIG. 7 is a schematic structural diagram of a primary power bank of the present invention;

FIG. 8 is a schematic structural diagram of an auxiliary power bank of the present invention; and

FIG. 9 is a schematic structural diagram of a key cap of the present invention.

### DETAILED DESCRIPTION OF THE INVENTION

In order to further explain the technical scheme of the present invention, the present invention is described in detail below by the specific embodiments.

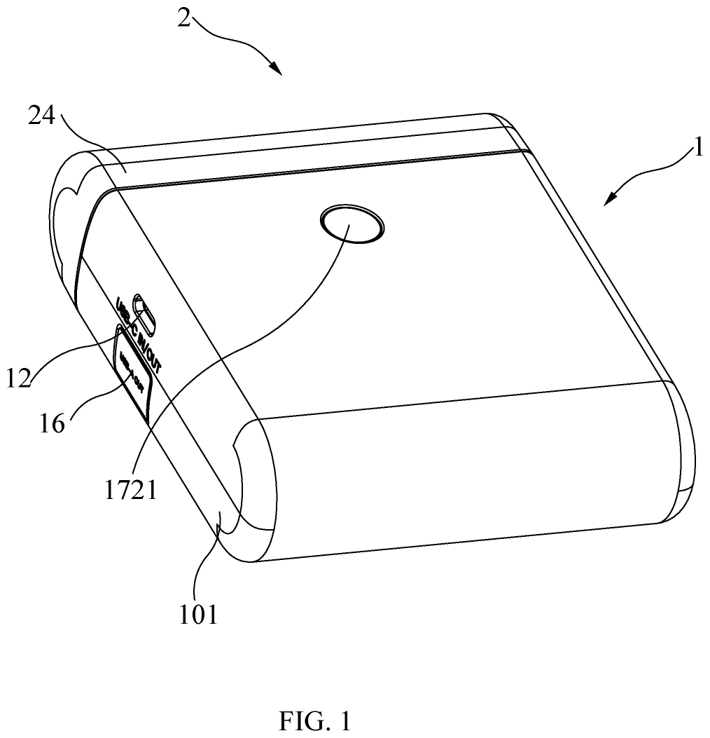

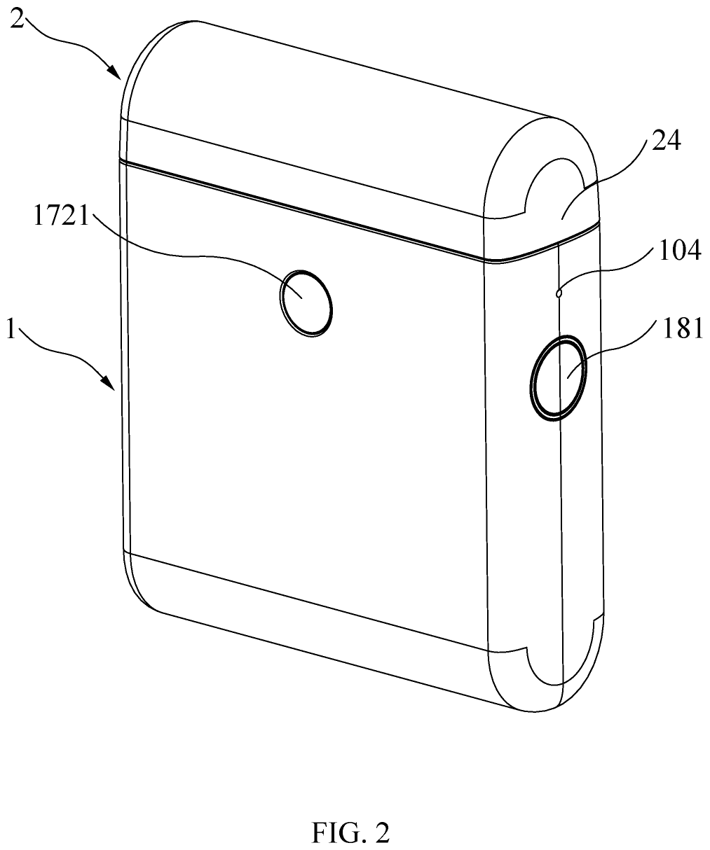

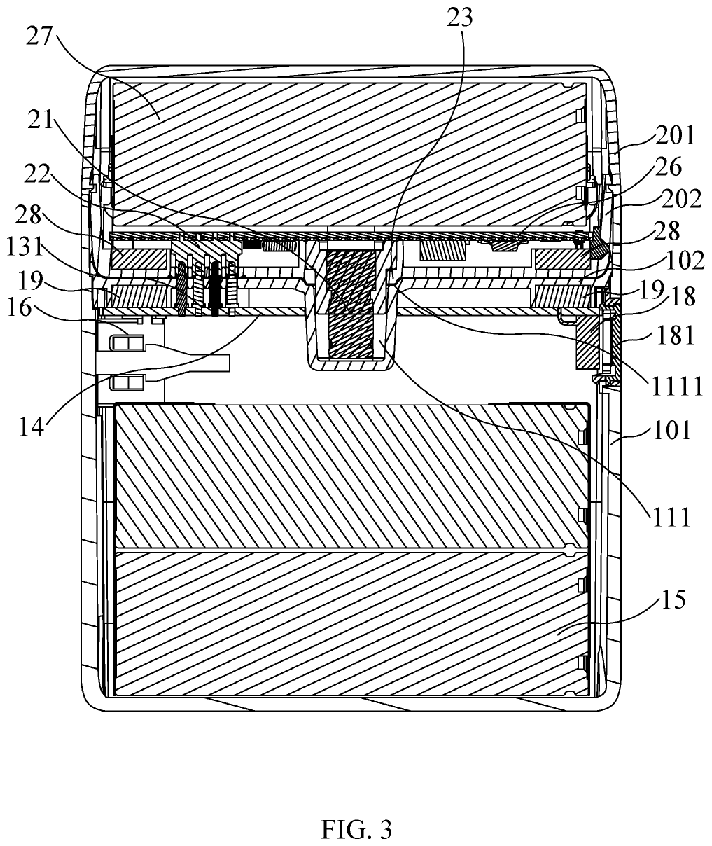

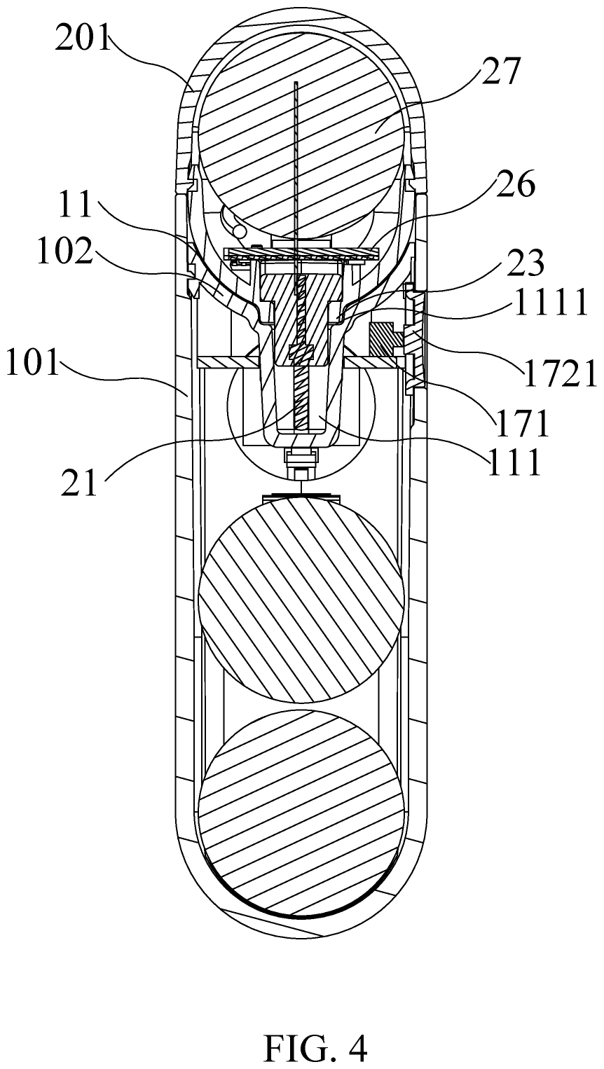

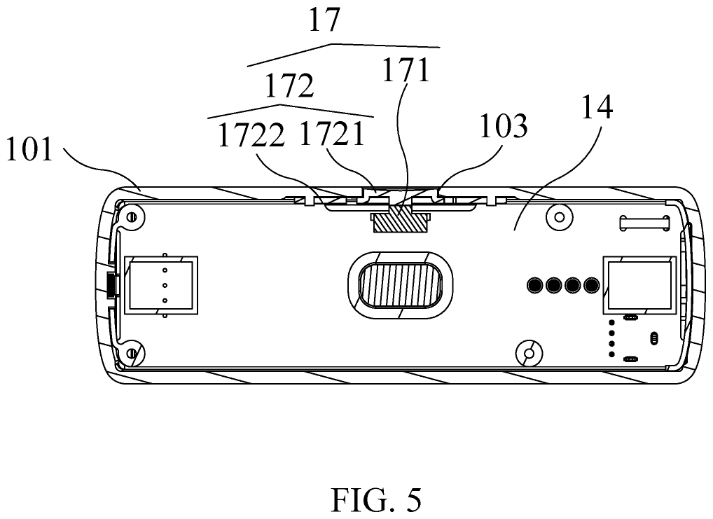

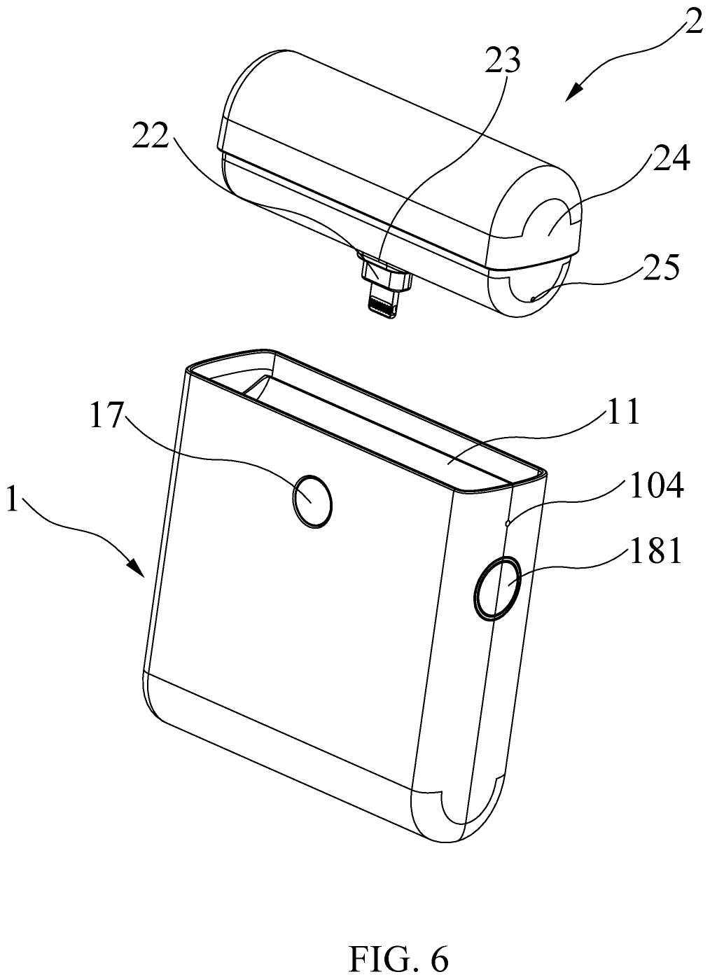

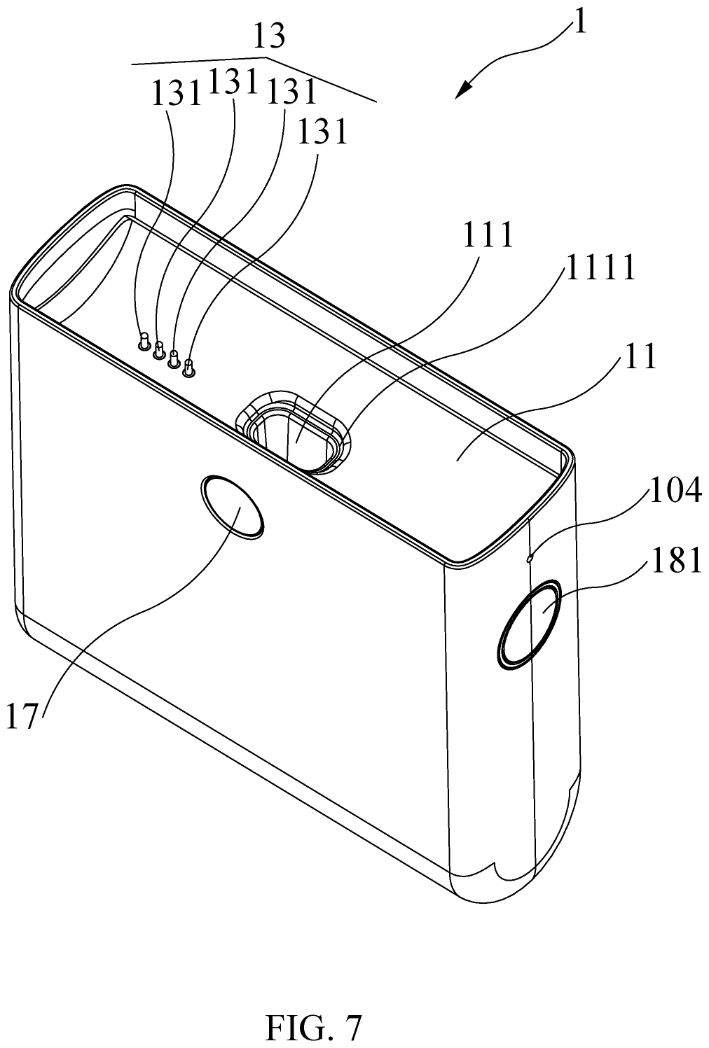

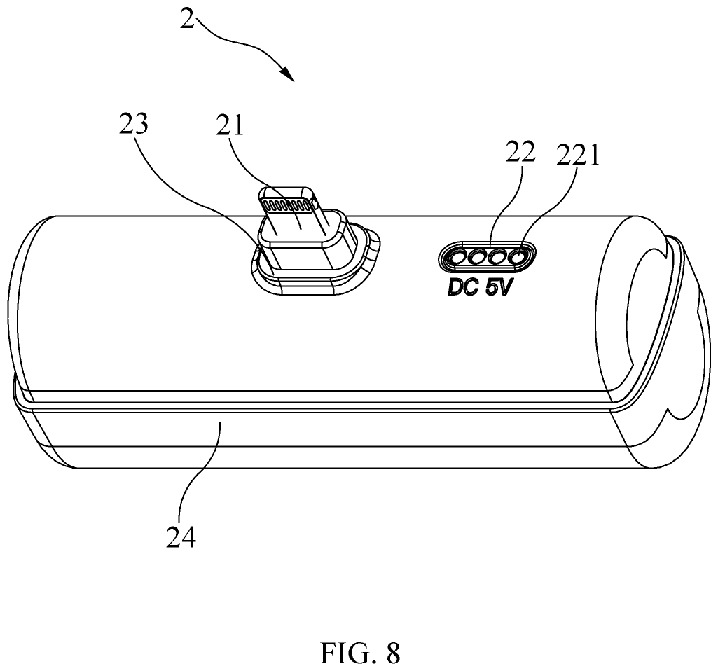

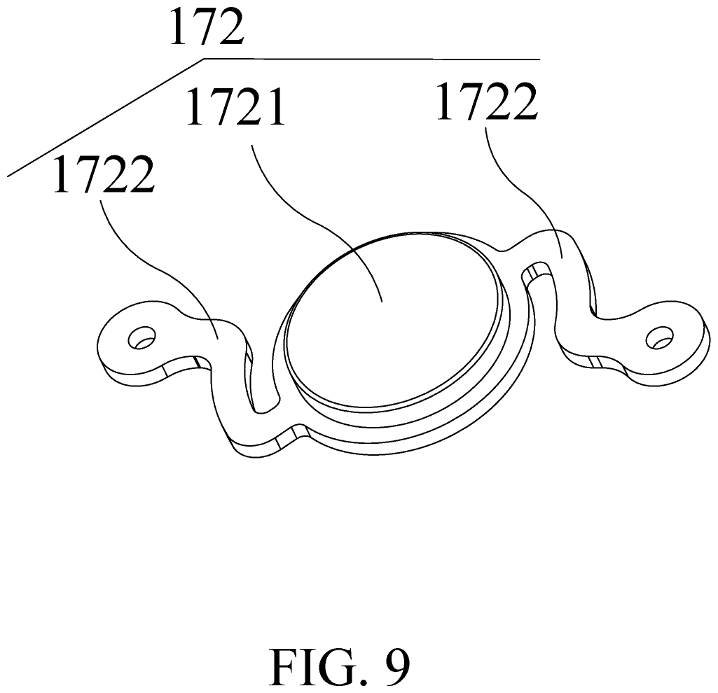

As shown in FIG. 1 to FIG. 9, the present invention discloses a power bank set, comprising a primary power bank 1 and an auxiliary power bank 2. A capacity and a size of the primary power bank 1 are both greater than a capacity and a size of the auxiliary power bank 2. The primary power bank 1 is provided with an assembling groove 11 and a main charging interface 12; a slot 111 and a primary discharging connector 13 are arranged in the assembling groove 11; the primary discharging connector 13 is used for discharging power. The auxiliary power bank 2 is detachably plugged into the assembling groove 11 of the primary power bank 1, and the auxiliary power bank 2 is provided with an auxiliary discharging connector 21 for discharging power and an auxiliary charging connector 22 for charging the auxiliary power bank 2. When the auxiliary power bank 2 is plugged into the assembling groove 11 of the primary power bank 1, the auxiliary discharging connector 21 extends into the slot 111, and the auxiliary charging connector 22 is interfaced with the primary discharging connector 13 so that the primary power bank 1 charges the auxiliary power bank 2.

In this embodiment of the present invention, both the primary power bank 1 and the auxiliary power bank 2 can independently charge an external electronic equipment, so that a user can select the primary power bank 1 or the auxiliary power bank 2 for charging according to different charging demands. The capacity and size of the primary power bank 1 are greater than those of the auxiliary power bank 2, so that the primary power bank 1 is suitable for a charging scenario in which the user requires high-capacity charging and/or a charging scenario in which the user does not need to hold the primary power bank 1. The auxiliary power bank 2 is provided with the auxiliary discharging connector 21 that can be directly plugged into a charging interface of an electronic equipment to charge the electronic equipment. The capacity and size of the auxiliary power bank 2 are smaller than those of the primary power bank 1 so that the auxiliary power bank 2 is lighter than the primary power bank. In this way, a load is relatively small when the user holds the electronic equipment and the auxiliary power bank 2, which will not pose a burden on the user during use. In addition, the primary power bank 1 and the auxiliary power bank 2 of the present invention can be detachably assembled together, which is convenient for the user to carry. When the primary power bank 1 and the auxiliary power bank 2 are assembled together, the auxiliary power bank 2 is plugged into the assembling groove 11 of the primary power bank, and the auxiliary discharging connector 21 of the auxiliary power bank 2 extends into the slot 111, so that the auxiliary discharging connector 21 can be effectively protected from being bumped and crashed. Also, the primary power bank 1 can also charge the auxiliary power bank 2, which is convenient for the user to charge the auxiliary power bank 2. Furthermore, the auxiliary power bank 2 is charged by the primary power bank 1 through the interface between the auxiliary charging connector 22 of the auxiliary power bank 2 and the primary discharging connector 13 of the primary power bank 1, which is helpful in effectively reducing the frequency of using the auxiliary discharging connector 21 and thereby increasing the service life of the auxiliary discharging connector 21.

In this embodiment of the present invention, the primary power bank 1 and the auxiliary power bank 2 are magnetically assembled with each other, so that the primary power bank 1 and the auxiliary power bank 2 are easily disassembled and assembled, and the primary power bank 1 and the auxiliary power bank 2 can be stably assembled together. The primary power bank 1 is provided with primary magnetic blocks 19; and the auxiliary power bank 2 is provided with auxiliary magnetic blocks 28 which magnetically correspond to the primary magnetic blocks 19.

In this embodiment of the present invention, the primary discharging connector 13 of the primary power bank 1 comprises a plurality of discharging contacts 131. The auxiliary charging connector 22 of the auxiliary power bank 2 comprises a plurality of charging contacts 221 which are used for being in contact with the various discharging contacts 131 of the primary discharging connector 13 respectively. When the auxiliary power bank 2 is plugged into the assembling groove 11 of the primary power bank 1, the various charging contacts 221 of the auxiliary charging connector 22 and the various discharging contacts 131 of the primary discharging connector 13 are in contact with each other, so that the primary power bank 1 charges the auxiliary power bank 2. The discharging contacts 131 of the primary discharging connector 13 and the charging contacts 221 of the auxiliary charging connector 22 are both magnetic contacts, that is, the auxiliary discharging connector 22 and the primary discharging connector 13 are both magnetic connectors. In this way, when the auxiliary power bank 2 is plugged into the assembling groove 11 of the primary power bank 1, the auxiliary charging connector 22 and the primary discharging connector 13 are magnetically attracted to each other, so that the auxiliary power bank 2 will be stably plugged into the assembling groove 11 of the primary power bank 1.

In this embodiment of the present invention, a housing of the primary power bank 1 may be formed by connecting a housing main body 101 and a housing end cover 102. The housing main body 101 and the housing end cover 102 may be connected by snap-fit. The assembling groove 11 is defined by a shape of the housing end cover 102. A stop step 1111 is formed at a circumferential edge of the slot 111 of the assembling groove 11, and a limiting portion 23 abutting against the stop step 1111 is arranged on a housing of the auxiliary power bank 2. According to the present invention, by using the limiting portion 23 to abut against the stop step 1111, the auxiliary discharging connector 21 of the auxiliary power bank 2 can be prevented from bumping and crashing with the primary power bank 1 when the auxiliary power bank 2 is plugged into the assembling groove 11 of the primary power bank 1, thereby protecting the auxiliary discharging connector 21. The auxiliary discharging connector 21 may be a TYPE-C connector or a Lightning connector or a MicroUSB connector.

In this embodiment of the present invention, a primary power bank circuit board 14 and at least one primary cell 15 are arranged in the primary power bank 1. The primary power bank circuit board 14 is electrically connected to said at least one primary cell 15, the main charging interface 12, and the primary discharging connector 13. The primary power bank circuit board 14 controls said at least one primary cell 15, the main charging interface 12, and the primary discharging connector 13 to achieve charging and discharging functions. The main charging interface 12 may be a TYPE-C interface, and the main charging interface 12 may achieve power discharging to external devices and power charging of the power bank set. The primary power bank 1 may also be provided with a secondary charging interface 16. A type of the secondary charging interface 16 is different from a type of the main charging interface 12. The secondary charging interface 16 may be a USB-A interface. In this way, the secondary charging interface 16 and the main charging interface 12 may be connected to different charging cable connectors to meet different charging demands of a user.

In this embodiment of the present invention, the primary power bank 1 may be further provided with an operation key 17 and a display screen 18 that displays a state of the primary power bank 1. The primary power bank circuit board 14 is electrically connected to the operation key 17 and the display screen 18. The display screen 18 may be used for displaying information of the primary power bank 1 such as a remaining amount of electricity and whether the primary power bank 1 is in a charging state or not. The operation key 17 may be used for controlling the display screen 18 whether to display information and controlling the primary power bank 1 whether to achieve charging of an external device. The housing of the primary power bank 1 may be fitted with a light-transmissive protective cover 181 covering the display screen 18 to protect the display screen 18. The operation key 17 may include a push switch 171 and a key cap 172. The push switch 171 is provided inside the housing of the primary power bank 1 and is electrically connected to the primary power bank circuit board 14. The housing of the primary power bank 1 is provided with a key hole 103 corresponding to the push switch 171. The key cap 172 comprises a key cap body 1721 and at least two elastic arms 1722 connected with the key cap body 1721. The key cap body 1721 is accommodated in the key hole 103, and each of the elastic arms 1722 is connected with an inner side of the housing of the primary power bank 1. The user pushes the push switch 171 by pressing the key cap body 1721, and the elastic arms 1722 can provide a push restoring force for the key cap body 1721 to enable repeated pressing of the operation key 17. In addition, the elastic arms 1722 occupy a small space in the housing of the primary power bank 1. The elastic arms 1722 may define an S-shape to allow the elastic arms 1722 to have a good push restoring effect on the push switch 171.

In this embodiment of the present invention, the housing of the auxiliary power bank 2 may be provided with a convex portion 24. When the auxiliary power bank 2 is plugged into the assembling groove 11 of the primary power bank 1, the convex portion 24 of the housing of the auxiliary power bank 2 flushes smoothly with the housing of the primary power bank 1, which avoids formation of a mismatched surface between the auxiliary power bank 2 and the primary power bank 1 during their connection, which may otherwise easily cuts and hurts a hand of the user, and is also contributive to improving the integrity of the auxiliary power bank 2 and the primary power bank 1 during their connection. The housing of the auxiliary power bank 2 may be formed by connecting a first housing body 201 and a second housing half body 202. The first housing body 201 and the second housing body 202 may be connected by snap-fit. The convex portion 24 is arranged on the first housing body 201, and the limiting portion 23 is arranged on the second housing body 202.

In this embodiment of the present invention, the auxiliary power bank 2 may be provided with a charging indicator 25 to indicate whether the auxiliary power bank 2 is being charged or not. The primary power bank 1 is provided with a light through hole 104 communicated with an inner cavity of the assembling groove 11 and corresponding to the charging indicator 25. When the auxiliary power bank 2 is plugged into the assembling groove 11 of the primary power bank 1, the charging indicator 25 of the auxiliary power bank 2 directly faces the light through hole 104 of the primary power bank 1, so that light emitted by the charging indicator 25 can be seen through the light through hole 104.

In this embodiment of the present invention, an auxiliary power bank circuit board 26 and an auxiliary cell 27 are arranged in the auxiliary power bank 2. The auxiliary power bank circuit board 26 is electrically connected to the auxiliary cell 27, the charging indicator 25, the auxiliary charging connector 22, and the auxiliary discharging connector 21.

The above embodiments and drawings are not intended to limit the form and style of the product of the present invention, and any suitable changes or modifications made by those of ordinary skill in the art shall fall within the patent scope of the present invention.

What is claimed is:

1. A power bank set, comprising a primary power bank and an auxiliary power bank; a capacity and a size of the primary power bank are both greater than a capacity and a size of the auxiliary power bank; the primary power bank is provided with an assembling groove and a main charging interface; a slot and a primary discharging connector configured to discharge power to an external device are arranged in the assembling groove; the auxiliary power bank is detachably plugged into the assembling groove of the primary power bank, and the auxiliary power bank is provided with an auxiliary discharging connector configured to discharge power to an external device, and an auxiliary charging connector for charging the auxiliary power bank; when the auxiliary power bank is plugged into the assembling groove of the primary power bank, the auxiliary discharging connector extends into the slot, and the auxiliary charging connector is connected with the primary discharging connector.

2. The power bank set of claim 1, wherein a stop step is formed on a circumferential edge of the slot; and the power bank is provided with a limiting portion that abuts against the stop step when the auxiliary power bank is plugged into the assembling groove of the primary power bank.

3. The power bank set of claim 1, wherein a housing of the auxiliary power bank is provided with a convex portion; when the auxiliary power bank is plugged into the assembling groove of the primary power bank, the convex portion of the housing of the auxiliary power bank flushes smoothly with a housing of the primary power bank.

4. The power bank set of claim 1, wherein the primary discharging connector is provided with a plurality of discharging contacts; and the auxiliary charging connector is provided with a plurality of charging contacts which are being in contact with the discharging contacts of the primary discharging connector respectively.

5. The power bank set of claim 1, wherein the auxiliary discharging connector and the primary discharging connector are both magnetic connectors; when the auxiliary power bank is plugged into the assembling groove of the primary power bank, the auxiliary charging connector and the primary discharging connector are magnetically attracted to each other.

6. The power bank set of claim 1, wherein the primary power bank and the auxiliary power bank are magnetically attracted to each other; the primary power bank is provided with primary magnetic blocks; and the auxiliary power bank is provided with auxiliary magnetic blocks magnetically corresponding to the primary magnetic blocks.

7. The power bank set of claim 1, wherein the auxiliary power bank is provided with a charging indicator; the primary power bank is provided with a light through hole communicated with an inner cavity of the assembling groove and corresponding to the charging indicator; when the auxiliary power bank is plugged into the assembling groove of the primary power bank, the charging indicator of the housing of the auxiliary power bank directly faces the light through hole of the primary power bank.

8. The power bank set of claim 7, wherein an auxiliary power bank circuit board and an auxiliary cell are arranged in the auxiliary power bank; and the auxiliary power bank circuit board is electrically connected to the auxiliary cell, the charging indicator, the auxiliary charging connector, and the auxiliary discharging connector.

9. The power bank set of claim 1, wherein the primary power bank is provided with an operation key and a display screen that displays a state of the primary power bank.

10. The power bank set of claim 9, wherein the operation key comprises a push switch and a key cap; the push switch is provided inside the housing of the primary power bank, and the housing of the primary power bank is provided with a key hole corresponding to the push switch; the key cap comprises a key cap body and at least two elastic arms connected with the key cap body; the key cap body is accommodated in the key hole; and the elastic arms are connected with an inner side of the housing.

11. The power bank set of claim 10, wherein each of the elastic arms has an S-shape.

12. The power bank set of claim 1, wherein the primary power bank is further provided with a secondary charging interface; and a type of the secondary charging interface is different from a type of the main charging interface.

13. The power bank set of claim 1, wherein a primary power bank circuit board and at least one primary cell are arranged in the primary power bank; and the primary power bank circuit board is electrically connected to said at least one primary cell, the main charging interface, the primary discharging connector, and the secondary charging interface.
